(19) United States
(12) Patent Application Publication
(10) Pub. No.: US 2009/0126198 A1
(43) Pub. Date: May 21, 2009

(54) CHILDREN'S CUTLERY

(75) Inventor: William Hsu, Taipei (TW)

Correspondence Address: SCHMEISER, OLSEN & WATTS, 22 CENTURY HILL DRIVE, SUITE 302, LATHAM, NY, 12110, US

(73) Assignee: TUNG LING INDUSTRIAL CO., LTD., Taipei (TW)

(21) Appl. No.: 11/940,389

(22) Filed: Nov. 15, 2007

(51) Int. Cl. B25F 1/00; A47J 43/28

(52) U.S. Cl. 30/123; 30/322; 30/324

(57) ABSTRACT

A piece of children's cutlery includes a work unit, a fixing unit, a plastic deformation unit, and a grip unit. The work unit is connected at an end to a front end of the grip unit, the fixing unit is connected at an end to a rear end of the grip unit opposite to the work unit, the plastic deformation unit is connected at two opposite ends to the work unit and the fixing unit, and the grip unit is enclosed around the plastic deformation unit and the ends of the work unit and the fixing unit connected to the grip unit. The grip unit and the plastic deformation unit enclosed therein may be adjusted by bending them to an extending direction and a curvature most suitable for holding by a user in a habitual position.

### FIELD OF THE INVENTION

The present invention relates to children's cutlery, and more particularly to children's cutlery that includes a grip unit allowing direct adjustment thereof by bending it to a desired extending direction and a curvature most suitable for a user to hold in a habitual position.

### BACKGROUND OF THE INVENTION

Children's cutlery, such as spoons, forks, etc., is generally integrally formed to include a handle and a food holding section located at a front end of the handle. The handle of such integrally formed children's cutlery is normally bent by a predetermined angle to be suitable for holding by children.

However, once the children's cutlery is integrally formed, the bent handle is non-adjustable. On the other hand, every user would hold a piece of cutlery in a different habitual position. Some people used to hold the cutlery with right hand, while others with left hand. To meet the habit of different users, every type of children's cutlery is manufactured to include two shapes separately suitable for right-handed and left-handed users. This would inevitable increase the manufacturing cost and the stock of the manufacturers.

In addition, while most users are different in finger length, finger thickness, and palm size, the handle of the integrally formed children's cutlery has fixed size, extending direction, and curvature, and could not be adjusted to meet individual users' need.

### SUMMARY OF THE INVENTION

It is therefore a primary object of the present invention to provide children's cutlery, such as a spoon or a fork, which has a grip unit allowing direct adjustment thereof by bending it to a desired extending direction and a curvature most suitable for a user to hold in a habitual position.

To achieve the above and other objects, the piece of children's cutlery according to the present invention includes a work unit, a fixing unit, a plastic deformation unit, and a grip unit. The work unit is connected at an end to a front end of the grip unit, the fixing unit is connected at an end to a rear end of the grip unit opposite to the work unit, the plastic deformation unit is connected at two opposite ends to the work unit and the fixing unit, and the grip unit is enclosed around the plastic deformation unit and the ends of the work unit and the fixing unit connected to the grip unit.

The grip unit is made of a flexible plastic material, and the plastic deformation unit is made of a malleable metal material. Therefore, the grip unit along with the plastic deformation unit enclosed therein may be adjusted by manually bending them to an extending direction and curvature most suitable for a user to hold in a habitual position.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a piece of children's cutlery according to a first embodiment of the present invention in the form of a spoon;

FIG. 2 is an assembled view of FIG. 1;

FIG. 3 is a vertical sectional view taken on line A-A of FIG. 2;

FIG. 4 shows a first manner of adjusting the children's spoon according to the first embodiment of the present invention;

FIG. 5 shows the use of the adjusted children's spoon of FIG. 4;

FIG. 6 shows a second manner of adjusting the children's spoon according to the first embodiment of the present invention;

FIG. 7 shows the use of the adjusted children's spoon of FIG. 6;

FIG. 8 is an assembled perspective view of a piece of children's cutlery according to a second embodiment of the present invention in the form of a fork; and

FIG. 9 is a vertical sectional view taken on line B-B of FIG. 8.

### DETAILED DESCRIPTION OF THE PREFERRED EMBODIMENTS

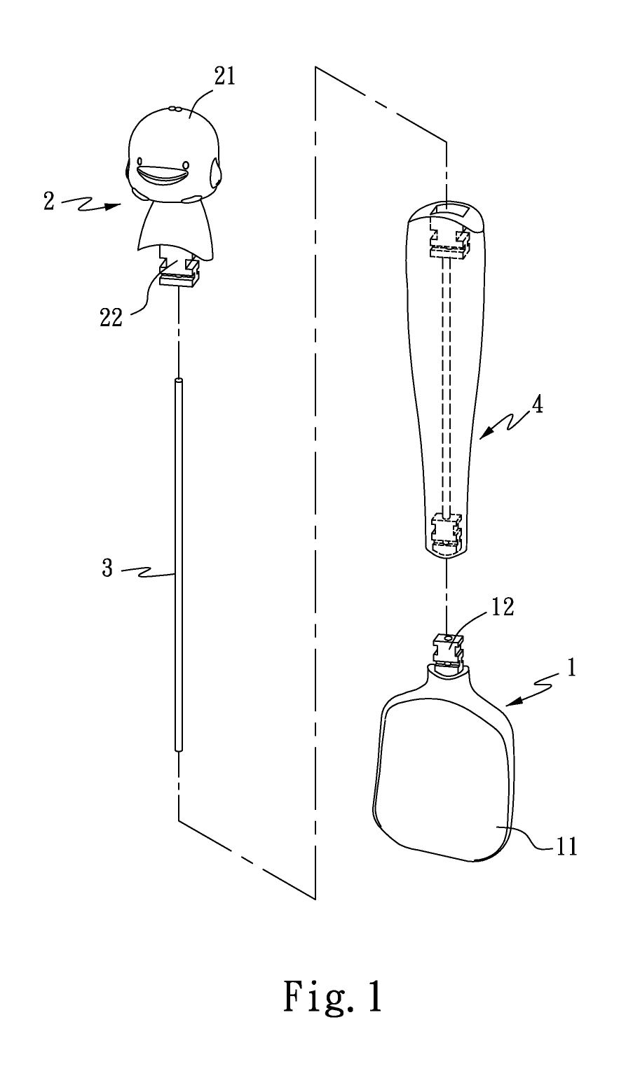

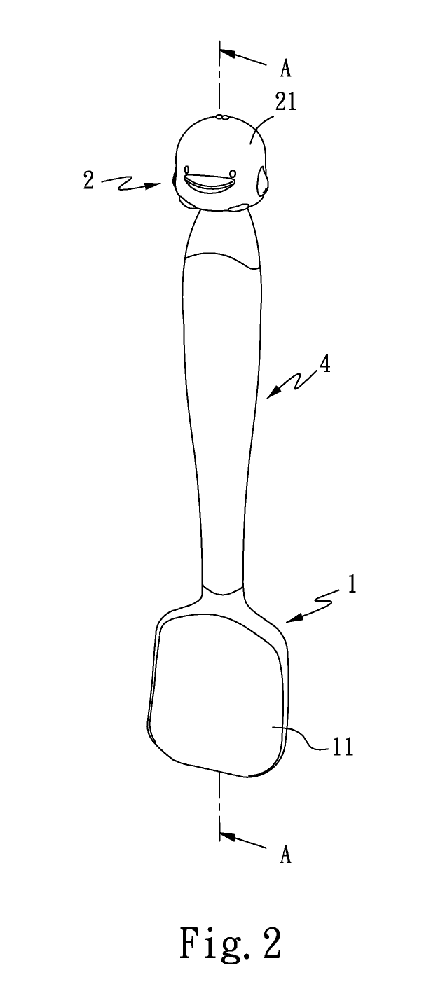

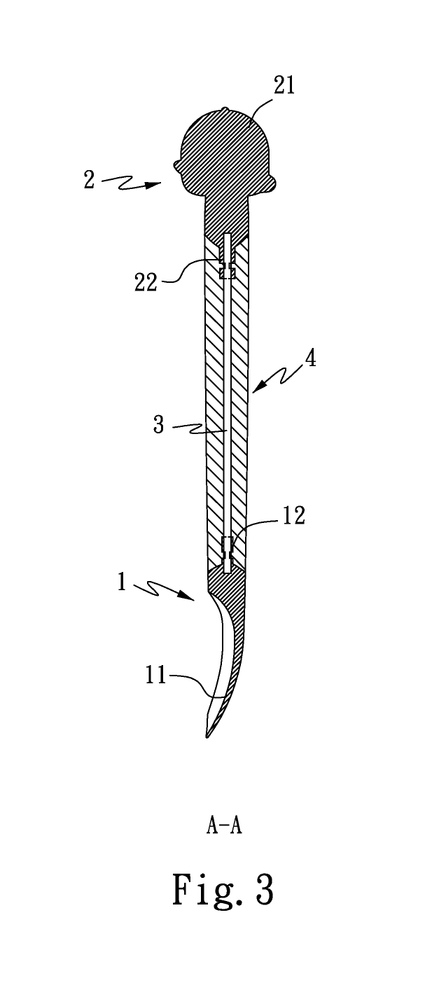

Please refer to FIGS. 1 and 2 that are exploded and assembled perspective views, respectively, of a piece of children's cutlery according to a first embodiment of the present invention, and to FIG. 3 that is a vertical sectional view taken on line A-A of FIG. 2. As shown, the piece of children's cutlery includes a work unit 1, a fixing unit 2, a plastic deformation unit 3, and a grip unit 4.

The work unit 1 includes a food holding section 11 and an interfering section 12 provided at an end of the food holding section 11 for connecting to a front end of the grip unit 4. In the illustrated first embodiment, the food holding section 11 is a shallow bowl, so that the piece of children's cutlery in the first embodiment of the present invention serves as a spoon.

The fixing unit 2 is connected to a rear end of the grip unit 4 opposite to the work unit 1, and includes an ornamental section 21 and an interfering section 22 provided at an end of the ornamental section 21 for connecting to the rear end of the grip unit 4. The ornamental section 21 may be in the form of a figure, an animal, a plant, or any other geometrical shapes.

The plastic deformation unit 3 is connected at two opposite ends to the interfering sections 12, 22 of the work unit 1 and the fixing unit 2, and is made of a malleable metal material.

The grip unit 4 encloses the plastic deformation unit 3 and the interfering sections 21, 22 of the work unit 1 and the fixing unit 2. The grip unit 4 is tapered toward the work unit 1, and is made of a flexible plastic material.

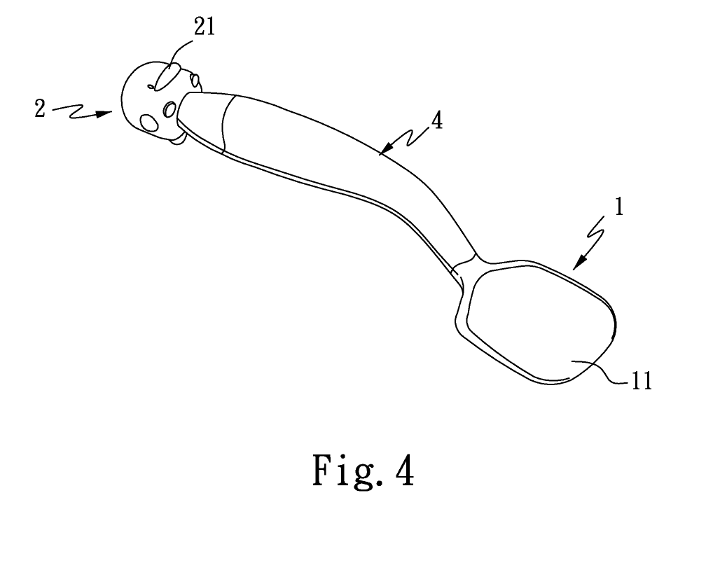

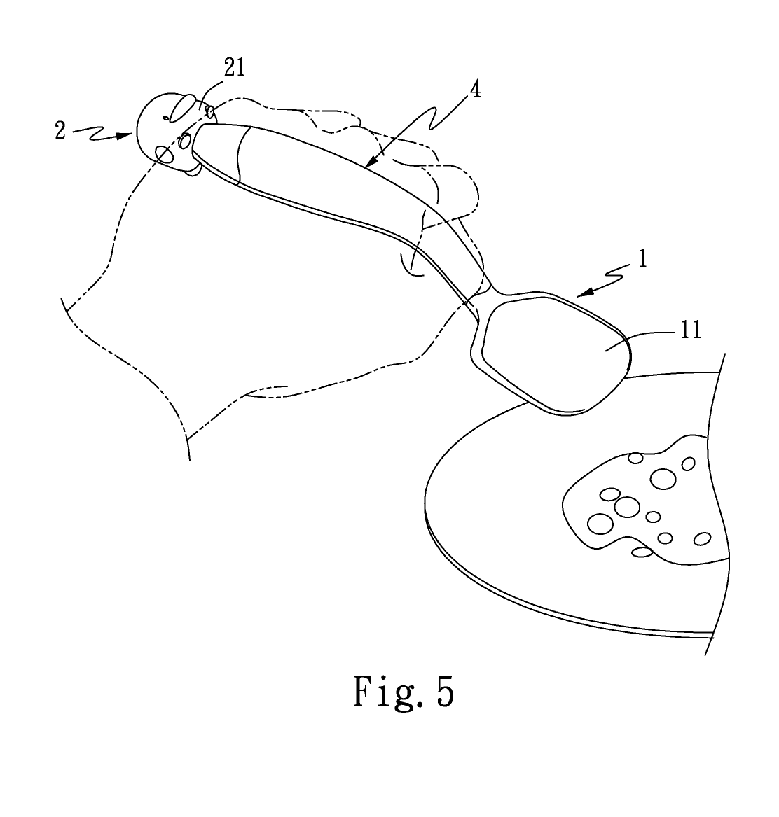

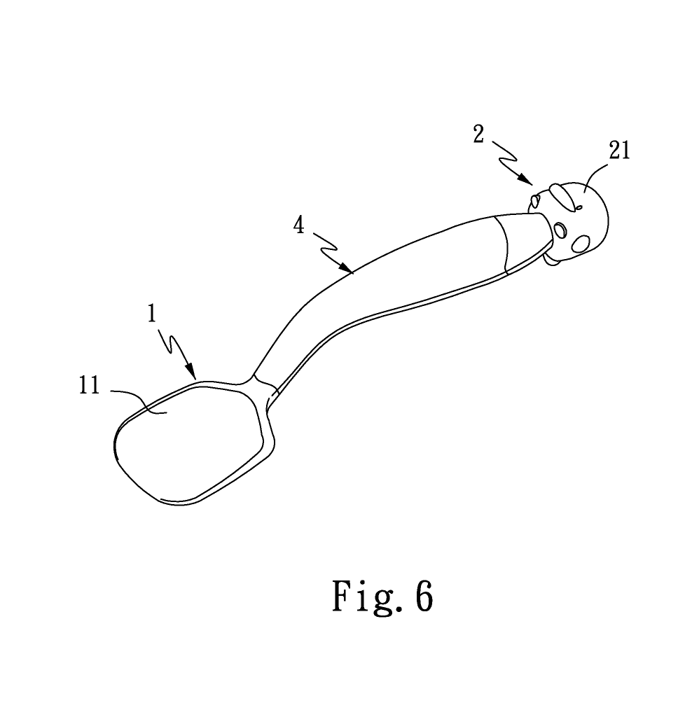

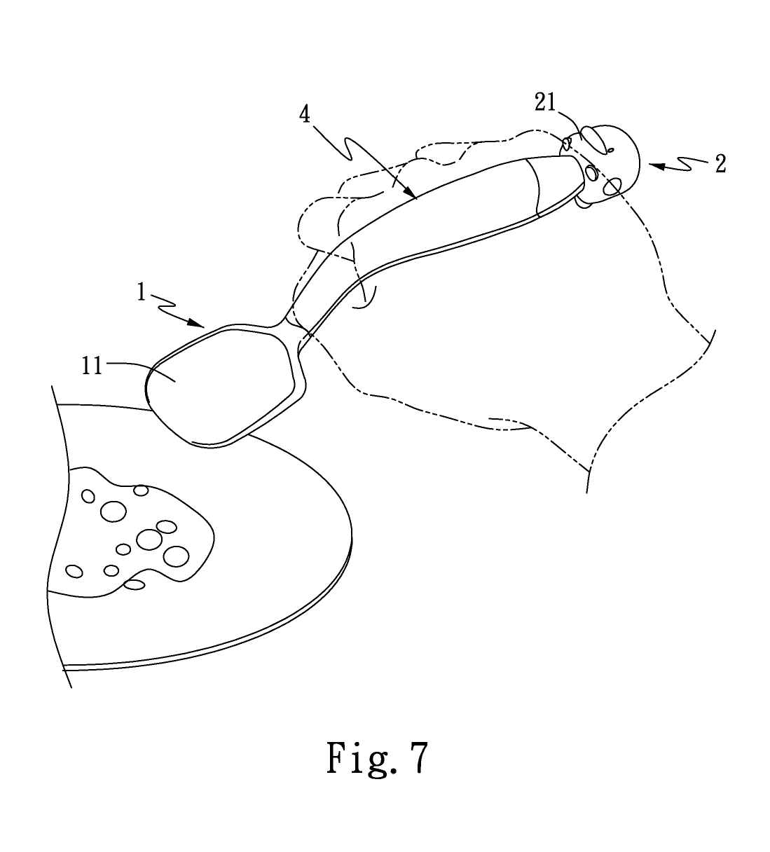

The children's cutlery provided by the present invention is particularly suitable for small children, and may be adjusted in the shape of the grip unit 4 to meet a user's habitual holding position. For instance, for a right-handed user, the grip unit 4 along with the plastic deformation unit 3 enclosed therein may be adjusted in shape simply by orienting the food holding section 11 of the work unit 1 toward the left side of the user and applying an external force on the cutlery toward the user, until the grip unit 4 is bent to an extending direction and a curvature most suitable for holding by the right-handed user to meet the body engineering, as shown in FIG. 4, so that the right-handed user may hold the grip unit 4 with right hand to take up food with the food holding section 11 in a habitual position, as shown in FIG. 5. And, in the case of a left-handed user, the grip unit 4 along with the plastic deformation unit 3 enclosed therein may be adjusted in shape simply by orienting the food holding section 11 of the work unit 1 toward the right side of the user and applying an external force on the cutlery toward the user, until the grip unit 4 is bent to an extending direction and a curvature most suitable for holding by the left-handed user to meet the body engineering, as shown in FIG. 6, so that the left-handed user may hold the grip unit 4 with left hand to take up food with the food holding section 11 in a habitual position, as shown in FIG. 7.

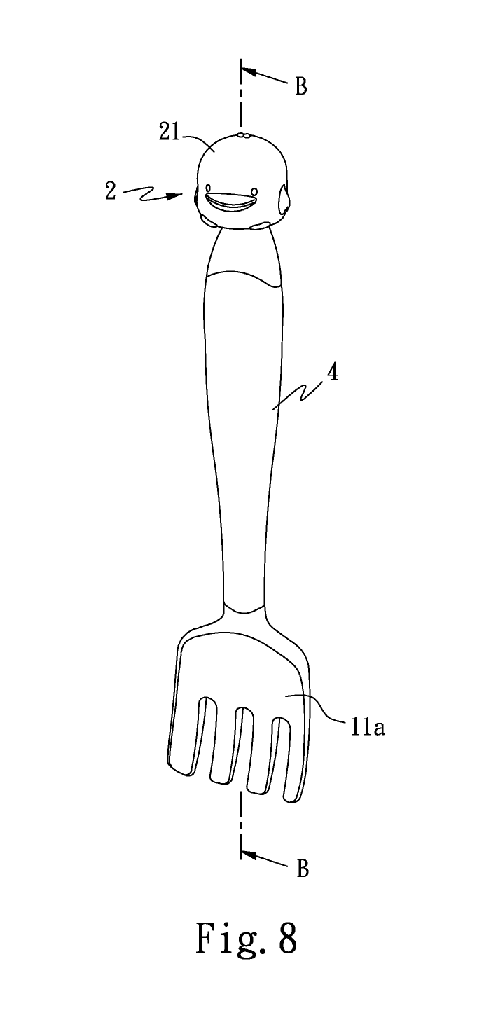

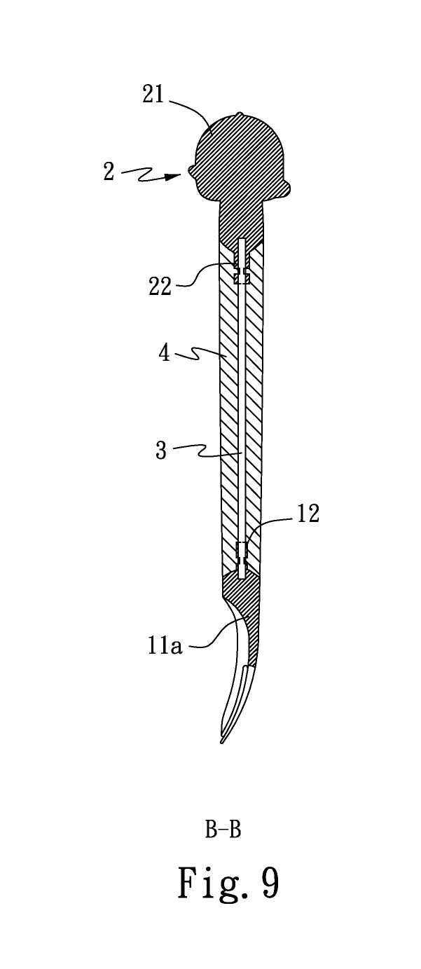

FIG. 8 is an assembled perspective view of a piece of children's cutlery according to a second embodiment of the present invention, and FIG. 9 is a vertical sectional view taken on line B-B of FIG. 8. As shown, a food holding section 11a in the illustrated second embodiment includes a plurality of prongs, so that the piece of the children's cutlery according to the second embodiment of the present invention serves as a fork. In the second embodiment, the grip unit 4 and the plastic deformation unit 3 enclosed therein may be adjusted in the same manner as in the first embodiment by bending them to a desired extending direction and a curvature meeting the body engineering most suitable for a right-handed or a left-handed user to grip for taking up food.

With the above arrangements, the children's cutlery according to the present invention has a flexible grip unit with a plastic deformation unit to allow direct bending of the grip unit to an extending direction and a curvature most suitable for a user to hold for taking up food easily. Therefore, the present invention has effectively overcome the drawbacks in the children's cutlery of prior art, and is more practical and valuable for use.

What is claimed is:

1. A piece of children's cutlery, comprising a work unit, a fixing unit, a plastic deformation unit, and a grip unit; the work unit being connected at an end to a front end of the grip unit, the fixing unit being connected at an end to a rear end of the grip unit opposite to the work unit, the plastic deformation unit being connected at two opposite ends to the work unit and the fixing unit, and the grip unit being enclosed around the plastic deformation unit and the ends of the work unit and the fixing unit connected to the grip unit.

2. The piece of children's cutlery as claimed in claim 1, wherein the work unit includes a food holding section and an interfering section formed at an end of the food holding section, and the work unit being connected at the interfering section to the front end of the grip unit.

3. The piece of children's cutlery as claimed in claim 2, wherein the food holding section is a shallow bowl for the piece of children's cutlery to serve as a spoon.

4. The piece of children's cutlery as claimed in claim 2, wherein the food holding section includes a plurality of prongs for the piece of children's cutlery to serve as a fork.

5. The piece of children's cutlery as claimed in claim 1, wherein the fixing unit includes an ornamental section and an interfering section formed at an end of the ornamental section, and the fixing unit being connected at the interfering section to the rear end of the grip unit.

6. The piece of children's cutlery as claimed in claim 1, wherein the plastic deformation unit is made of a malleable metal material.

7. The piece of children's cutlery as claimed in claim 1, wherein the grip unit is tapered toward the work unit.

8. The piece of children's cutlery as claimed in claim 1, wherein the grip unit is made of a flexible plastic material.
